(19) United States
(12) Patent Application Publication
(10) Pub. No.: US 2017/0372016 A1
(43) Pub. Date: Dec. 28, 2017

(54) Building up for Unified Index Database for the Characteristics for the living Bodies' Meridian and Acupoints and Their Normal Values Setting for Their Applications

(71) Applicant: Kai Jiang, Brooklyn, NY (US)

(72) Inventor: Kai Jiang, Brooklyn, NY (US)

(21) Appl. No.: 15/731,482

(22) Filed: Jun. 19, 2017

(51) Int. Cl. G06F 19/00

(52) U.S. Cl. CPC G06F 19/322; G06F 19/324; G06F 19/3418

(57) ABSTRACT

The invention disclosed an intelligent system for design Database Setting up for standard various studies data refer to characteristic of the Meridians and Acupoints actions of the living body. And based on them, said the system set up an intelligent databases center for the Unified Indexes for various bio-energies measuring value from the meridians and their acupoints data. The invention can automatically combine and carry out the functions of measurement, diagnosis, and treatment, and also, depend on specific personal health background said the system can automatically set up the further suggestions for the treatment procedure in a special time at special acupoint(s) for the person. The invention can be used for clinic in many different diseases timely diagnosis and treatments, also for the drug development, the research for the principle of the meridian. Said the system can be used in the any intelligent terminals by websites, like cell phone for daily health care area.

### CROSS-REFERENCE TO RELATED APPLICATIONS

This invention is continuation-in-part of following the prior application and also claims the benefit of U.S. provisional patent applications of: U.S. 62/177,609: (Mar. 19, 2015), and U.S. Ser. No. 14/999,018: (Mar. 18, 2016), U.S. 62/493,120 (Jun. 23, 2016) and the Chinese patent CN 20575897.1 U (Dec. 7, 2016) and the disclosures of which are also hereby incorporated herein by references.
Inventor: KAI JIANG
Applicant: KAI JIANG
Submit date: Jun. 15, 2017
Customer Number: 123977
Mail Address: 1209 Ovington Avenue 2^{nd} Floor, Brooklyn, N.Y. 11219
Telephone Number: 1 347 217 8533 (USA)
US Classification:
CCL: 128/907, 128/920, 128/923, 600/300, 600/354, 600/361, 600/382, 600/384, 600/584, 606/189, 607/2, 706/20
CPC G06F19/32, G06F19/322, G06F 19/324, G06F19/3418,

International: A61B5/05, A61B5/05, A61B10/00, A611139/04, A611139/06, A61H39/08,

### PATENT REFERENCES

| | Inventor | Publication Date |
|---|---|---|
| US Patent References: | | |
| U.S. Pat. No. 2,012,376 A | Miles Lawrence D. | Aug. 27, 1935 |
| U.S. Pat. No. 2,716,979 | Pierre Pouret | Sep. 6, 1955 |
| US20040122709A1 | Gopal Avinash | Jun. 24, 2004 |
| U.S. Pat. No. 8,498,879B2 | Francis Michon | Nov. 10, 2008 |
| U.S. Pat. No. 9,589,106, | Bangera; MahalaxmiGita | Mar. 7, 2017 |
| International Patent | | |
| References | | |
| CN 201806693 U | Yongxing Fang | Mar. 15, 2010 |
| CN 102949175 B | Zhengguo Lai | Aug. 18, 2011 |
| CN 20575897.1 U | Kai Jiang | Dec. 7, 2016 |

### Other References

<<Huang Di Nei Jing>>People's Health Publishing House. 1963. (Chinese)
Chinese Standards of Acupuncture and Moxibustion (Read at 2017 May 26) http://zgzjbz.caam.cn/work/Index.html

The world Federation of Acupuncture Moxibustion: Location of Points GB12346-90 www.wfas.org.cn/standard/dingwei/indexhtml
Guo Jie Sun, <<Acupuncture and Moxibustion>>People's Health Publishing House. 2000. (Chinese)
Terrence Pan <<Meridian Password>>(Chinese) http://wwvv.chtr.org.tw/40/1101.pdf Chao Dupuis, A Brief History of Acupuncture in West. 2010 Sep. 15. http://yinyanghouse.com/acupuncture/a-brief-history-of-acupuncture-in-the-west
Wen-hui Liu, et al: Acupuncture, needleless-acupuncture and Bioelectrical Therapy. (Chinese, read at 2017 May 2) http://www.wenkul.com/view/AB3FD56C7F1EF9C9.html
Yu-ling Wang, <<Bioelectric Medicine with Chinese Medicine>>(Chinese), 2008. http://yixue.lzbjs.com/download/VSXYXZCXXWCWAN.html
Andrew C. Ahn. et. al. Electrical Characterization of Acupuncture Points: Technical Issues and Challenges. J Ahern Complement Med. 2007 October; 13(8) 817-824.
Helene M. Langevin, et al. Paradoxes in Acupuncture Research: Strategies for Moving Forward. 2011; 2011: 180805.

### DESCRIPTION OF INVENTION

For clearly describe the invention, following names will be abbreviated: Traditional Chinese Medicine (TCM). Biologic Energy Nutrition Concept/theory (BENuology). Intelligent Center Host (Host). Intelligent Terminal (IT). (If more than one Host or IT linked together and not emphasizes any one, then just collectively as: said (the) device). Meridians' Time Active Law (MTAL). Meridians activation information (mci), One Chinese-day (Cday). Small Chines Month's Cycle (sCMC). Big Chinese Month Cycle (bCMC). Chinese Year Cycle (CYC).

### FIELD OF THE INVENTION

UNIFIED INDEX Databases for the characteristics for the living bodies' Meridians and Acupoints and their applications. TCM and Meridians theory. Drug research method. Automatic diagnose and treatment. Clinic. Cell phone function. Remote diagnosis and treatment.

### BACKGROUND OF THE INVENTION

The electoral current and its waveform measurement at special areas of body surface had been used for diagnosing heart diseases for long time. But this measurement method neither use for treating heart diseases, nor testing for any other disease, not to say combine with treatment together treating body in same test point which used for the measuring directly.

Acupuncture, as a special method for various diseases treatment in clinic, its knowledge of characteristics for the Meridian and their Acupoints of the living body are very important for the clinic treatment. Even though there is a Traditional Chinese Medicine (TCM) theory to explanation vivo system of living body, but the ideas however, is totally different with the modern medical theory and the discoveries. Therefore, the knowledge of the TCM is hardly accepted by western world especially by western medicine academia.

Even though the history of the western medicine almost as long as the TCM, and it has been several hundred years since the needle treatment spread to west societies, and developed in its application in charging current on the needle, but it is hardly to understanding its principle. Last century the Japanese and Germany researchers found that some special points on persons' skins which have distinct electrical properties, and they are all well matched, therefor well proved with the acupoints which had been introduced by TCM for thousand years ago. Since then, the acupuncture and their meridian theory began to be officially noted by western. However, because the two systems of the medical theory are based on totally different system concepts, and their theoretical and development experiment ways are also completely different. So, both sides of the academic communities reject each other's theory and the methods: On the one side, Western medicine based on its solid scientific methods and its astronomical number success cases! So it has real material basses. On the other side, CTM has thousands years of practice and in countless successful cases and their dependent on their theory, especially the special acupoints were proved by the Western doctor researchs, and more, many case were successfully cured which ware failed by methods of the Western medicine treatments.

In order to unify the two medical theory, many researcher did their effort;

there are many devices had been used for the measurement for the electrical current, resistance, electrical conductivity and these indexes' strength [U.S. Pat. No. 2,012,376 A, Aug. 27, 1935. U.S. Pat. No. 2,716,979, Sep. 6, 1955. And Terrence Pan 2008. Chao Dupuis, A 2010. Andrew C. Ahn. 2007. Guo Jie Sun, 2000], these let the persons try to explain the principles of how are the meridians' working. But, they were minimally used in measuring for Acupoints' electrical resistance strength and never been used for purposes of setting up the database for UNIFIED INDEXEs for the world for Acupoints' in any test item like: electrical resistance, electrical current and their waveforms, electrical conductivity and the magnetic fields well as the pH values, etc. Also, because of two different medicines concepts are totally different said above: The CTM concerned about the overall body's Ying-Yang balance; body's organs' relationships and effects each other and their meridians are well if they are in balance. But the TCM couldn't answer the question that ‘where is the anatomic support’ of the ‘meridian and their acupoints’?

While the western medical focus on the details; the reasons, can be anatomically seen, the molecular and their reaction and their effects on the cells and organs of the body; no cells' problem will no body's problem. But the modern medicine couldn't answer the question that: “why the acupoint Zusanli (ST 36) can be used for treating the kidney failure” and “why the acupoint Neiguan (PC 36) can be used for treating the heart failure”? Even though some on tried to explain the activation of the meridian by usage of meridian treatment devices, however, because no breakthrough on their theory, so their explanation still finally got back to their own home (Terrence Pan, 2008. Yu-ling Wang, 2008). Also, the western researcher use the electricity to treat different illnesses [US 20040122709A1, 2004. U.S. Pat. No. 9,589,106, 2017. U.S. Pat. No. 8,498,879B2 2008. CN201806693U, 2010. CN102949175B, 2011], however, most of them were just stayed on the step of ‘cases’ collection’; still no breakthrough for their theory for it. So now still neither the western medical theory nor the TCM theory could well cover to the knowledge of the data indicators' characteristics in such like the electrical resistance, electrical conductivity and the magnetic fields in the local point for different Meridians and their Acupoints, not to mention the inherent mutual relationships between them. Moreover, the inherent mutual relationships to the normal physiology and clinic pathology in different diseases refer to above said data indicators. To figure out the faces of the meridian actions and by through it to research and explore TCM to unify the all medicine concepts, for the First Step, the setting for the UNIFIED INDEXEs for Meridian and their Acupoints' measurement dates are necessary, after all, the way can be recognized by both sides. The second, from the scientific point of view, since the acupoint have been confirmed, no one has further to prove their law of activities. So, measuring the acupoints relative values of the meridians and on the Unified Indexes and compares their changes over time to prove their activity patterns change over time are very important.

There are several laws of activities have been introducing by the theory of the Zi-Wu flowing ( [symbol] ) of CTM in more than thousand years ago, they told us that the acupoints will more active in their specific time period, and treating these acupoint in said specific time would have more powerful for the diseases treatment and would have much better effects. So if the law of the activities could been proved and programing them to the special devices which can sent treating signals to the detector at the specific time period on said acupoints will have much better effects for the diseases treatment or could care these disease by frequently treatment.

Second; if person were in abnormal inner condition and some acupoints of this person will also be in abnormal and they can be checked out by measurement. And for different disease, there have different acupoints will have their inner changes. So exploring for these changes in different disease and also compare them with the normal relative meridians and their acupoints, should help us to diagnoses and further to treat such illness especially in the active time period of these acupoints.

Therefor, the Unified Indexes for each acupoint measure data is important. Also, treatment device which has the program about the automatically measure and then directly automatically treat the body in some special points will be helpful for the both sides concepts, on this basis to get a unified understanding. These are very important for clinical, also for personally self-care.

Have noticed that the invention CN 10294917B (2011 Aug. 18, also some machines) has asked claim for the drug test by use of the meridian test, however, neither its description nor figures of the system in usage of DIRECTLY test the effecting of the drug in the activation of the meridian because the system just test the drug: “a drug testing unit is connected to the second electrical transmission interfaces to the host for the drug to detect a corresponding electromagnetic wave electronic analog signal, . . . ”. Also, in its FIG. 2: the numbered 131 completed separated with 151, as well as in the same relationship between the S6 and S2 in its FIG. 6. So, such a design completed excluded out for direct testing the drug effects to the living body, not to say to explore the time of the actions of the drug in vive for their meridians' movings.

In my previous patent application (U.S. Ser. No. 14/999,018) and Chinese patent CN 20575897.1U, Dec. 7, 2016 I disclosed an invention for a treatment method for the coil set which can generate electromagnetic field use to the needle treatment. The coil set can combine magnetic field, needle puncturing, electrical and worm stimulation together in same acupuncture point (Acupoint). That invention is based on the CTM theory and its practical treatment experiences, not based on the modem medicine theory. For obtaining and setting up the UNIFIED INDEX of above said DATABASEs; and in favor of the needle treatment explanation in theory, helps and guards the application of treatment in clinic, this invention is continually for the prior invention of U.S. Ser. No. 14/999,018 they belong to a series of the invention applications which try to unified the concepts for the CTM and the modem medical theories.

### SUMMARY OF THE INVENTION

The invention disclosed a system for design to establish the UNIFIED INDEX of the database of the meridians and acupoints measurement data and the measurement is according to said meridian and their acupuncture characteristics activities following the time in the living body. The database including at least one following detection indicators of the electrical resistance, the electrical current and their frequencies and waveforms, the capacitance, the conductivity, magnetic field, temperature, electromagnet and their waves and lights and their waves, and the pH values and temperature values in inside and or at the surface of said the acupoints of the meridians in living body. The database and their Unified Index could be used as new diagnostic indicator for clinically health, and also for the detector for new drugs functions and their development. The invention include the various methods for obtain the different information which reflect the meridian and their acupoints' characteristics of above said indexes data or values of the measurement. And said the data use on the research for inherent mutual relationships between the meridians, and their acupoints in said the database, and the inherent mutual relationships to the normal person and various patients suffer with different diseases and the database use in the normal life and clinic for different diseases treatments. Also, the characteristics biologic energies recorded from the health person, and return them back to the sickness persons to cure them; is important experiment for the “Biologic Energy Nutrition” concept and for establishment of the theory of the BENuology and others so said.

Persons are measured their bio-indictors and the data are transferred into the host for classified by their persons' health history into the normal and abnormal, then further divided with their gender as well as different diseases. The abnormal groups should continually separate into more detail groups for each individual disease. For each group should have their own data indicators value, each characteristic database value will be found and also set in each individually group. So, for the person who's some specific acupoint measured data are limited on the value of a certain disease' or specific disease group paten(s), then this person will be danger for suffering this disease. If the person's several data indicator are close to that certain disease, that means of this person is high risk crow of suffer those diseases. In this situation, the device will automatic sent the treatment signals to the detector to treat that person in same or other specific acupoints in a special time period; because according to the theory of the acupuncture: each meridian has their own active time, specific acupoints activate at specific time. Most important is this method is safety for clinic disease treatment.

The number for the figures:

1 The information of the persons and their health background.

2 The information from 1 bind with to 3.

3 Same persons of above 1 are tested their meridians and acupoints indicators.

Notice: from 1 to 3 is the Step A: the raw data collection and treated preliminarily.

4 The information from box 3; Step A are transferred into the Intelligent Database Center, Step B: Meridian databases are established for each standards and their curves based on each time law of meridian activities.

5 The health persons' groups and non-health persons' groups are separated in this step. The data information from box 3 are combined with the data of above measured meridians and their acupoints and statistically calculated with the meridian's activation time point to set up each individually standard data and the curve of their individual time law.

6 The path of the information from 5 to 7.

7 The Meridian Databases are established for each of their standard and their curves based on each time law of meridian activities. The UNIFIEDF INDEX of each group of which every calculation factors have been added in are set. It is a part of Intelligent Database Center.

8 The new raw data resources: from this kind of device the new raw data from new persons with their health histories and the persons which have been measured before are measured and the data are transferred with their health histories update to the 7, to rich, full and perfect the said databases and the UNIFIED INDEX for increasing the number of the samples calculated statistically for the data volumes of said meridians and acupoints in the Host.

9 The data signal information from device 8 through this path by linking line or wireless into the Host directly or by website or other ways indirectly.

10 The suggestion signal information from the Host through this path by wire or wireless into the device 8 directly or indirectly. The suggestion signals comprise the diagnosis conclusion, and direct treatment programs and signals for automatic treatment, or its suggestions for the manual selection signals and other measuring signals, and so on.

Notice: the line 9 and 10 can be combined come together, the figure just try to clearly show the details.

11 Any kind of Person—Machine communication path way: especially for the Doctor, which marked as 25 in figures.

12 The monitor which the data, character, figure, graph, data curve and voice signal from said the device can be seen on it.

13 The answer signals' path from monitor to said the device.

14 the command signals' path from said the device to the monitor.

Notice: the line 13 and 14 can become together, the figure just try to clearly show the details.

15 The Host of Intelligent Database Center. The 15′ is any other 15.

16 The measurement signal path, the measurement signals from the detector (not shown in the figures) pass through this path to said the device directly or indirectly.

17 The measurement order signals from said the device to the detector (not shown).

18 & 19. The treatment signals from said the device to the treatment detector (not shown) which is used to detect the relevant data of the said meridians and their acupoints: the dotted line 19 means that the treatment signal is indirectly go to the treatment detector, that is for manual selection for the treatment methods. While the solid line 18 means that the treatment signal is directly go to the treatment detector for automatic treatment.

Please notice: the detector (not shown in the figures) can be designed to bind both measuring and treating functions and return the signals back to said the device. And the lines 16, 17, 18, 19 can combined together; the figures just try to show the details clearly.

20 Connection direct or indirectly between the 15 and 15′, and their database will be exchanged to combine to the more completed database.

21 is showing Step C; the database for the persons meridian and their acupoints action characteristics are well set up from several UNIFIED INDEX Data Generator of the Host 15 and 15′; because the number of statistics have been enough for their statistic value which have been able to show the characteristic of local population meridian and their acupoints activations. There might be some different in the UNIFIED INDEX Database in different countries in the world because of the racial differences and so on.

24 is any different kind IT like cellphone, laptop, the office computer which has combined functions of measurement and/or treatment for the said meridians and acupoints. They are connected with the center Host by the wire or wireless shown by double arrow dotted line 23 in the FIG. 2, respectively.

26 is manual communication between the Doctors 25 with the devices 8 for their measured data, diagnose and treatment ideas after each time of measured data, diagnose and treatment. Depend on that, Doctors will make final decision for treated patient.

### BRIEF DESCRIPTION OF THE FIGURES

FIG. 1 is very simplified schematic the steps from raw data collection to completely set up the database and the Unified Index for said measurements.

FIG. 2 is very simplified schematic the device working principle for combine measurement-treatment functions together. And the connections of the Host with other devices.

FIG. 3 is very simplified schematic that the doctor's position in meridian treatment procedure

### DETAILS OF THE INVENTION DESCRIPTION

The first of all, the persons (box 1) which have their health background information are measured for their different meridian/acupoints and the data are recorded in the test device showed as box 3, and 2 means the persons' general health background information 1 bind with 3, the bundled data are transfer by path 4 to the UNIFIED INDEX Data Generator of the Host 15 to finished step A: the raw data collection.

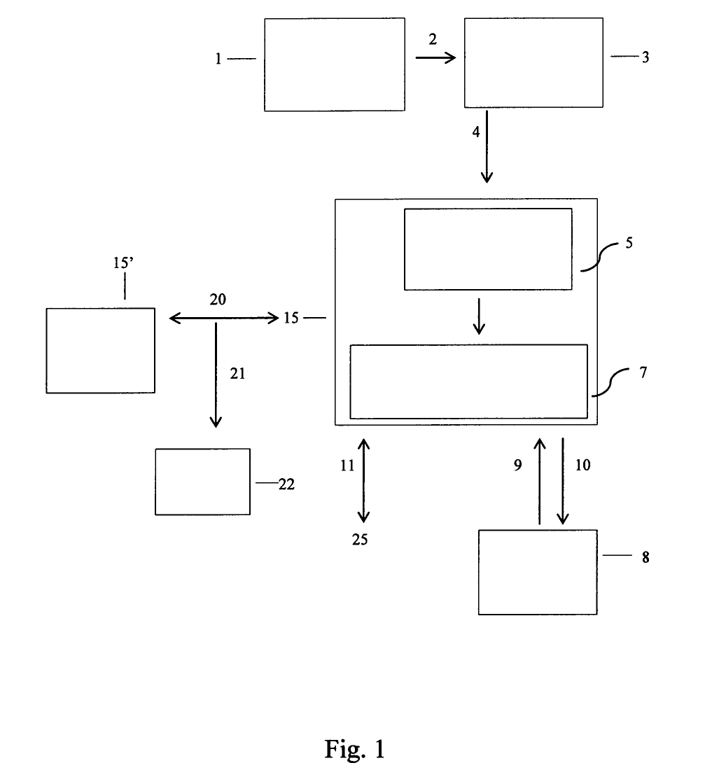

In the step B, in Host showing as 15 in the FIG. 1, the data from the box 3 are further with treated statistically to separate into different groups based on each person's individual health background; the health male and the health female and in which comprise different sub groups based on different age. Also corresponding to the each health groups, the each patient group are also set for different disease. Depend on their groups, individual persons' meridian data are statistically counted and the primary standard data are set for each group like showed as box 5. Then, as showing in the box 7 each data is transferred by 6 and treated by the MTAL of each individual measured meridian which its raw data came from as said above step A, and the individually database of specific meridian for special said group is set up in the step B and each individual Index volume will also be set. Please notice here, said the MTAL can be deal with in any step of above procedure, in the figures just try to show the principal clearly.

According to the traditional meridian theory of the specific meridian/acupoints are more active in special time, and the acupoint are different in their inner condition when person is in sickness or health, and for specific illness there are specific acupoints could cure them. So when the new raw data continually getting from the device 8 through 9 and these new data information will be added to different database group depend on their health background and treated in said the 15 of 7 statistically to perfect or called update their database. According to the law of measured meridian, and compare the data from 8, the Host will automatically diagnosis the data fresh get from 8 is normal or not, and if it were abnormal, which disease's meridian acupoint activation data is the most march the data from 8 in that measurement time, depend on treat the data by statistics comparison and the analysis, said the Host will automatically sand conclusion to 8 for the data that if they are abnormal or not, if there were abnormal, what the disease is the most possible for that data's host person, what the acupoints should be used for treating that disease depend on the one of said the MTALs, and what is the best time to treat these specific acupoints. Above information from said the Host will automatically transfer to the device 8 by path 10. Said the Host can be used for any medicine worker 25 by the path 11 of the FIG. 1. The functions and the databases can be shared between different Hosts 15′ and the Unified Indexes, and are set up for larger range 22 by 21 till the entire world.

Because in different race, their meridians' activation law may have some different, so in different area may need its own database and independent Unified Index.

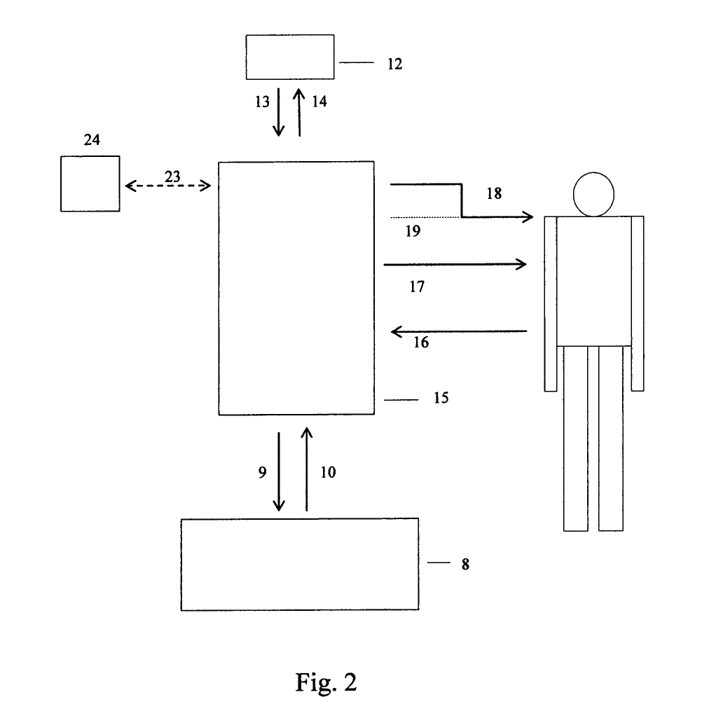

In the FIG. 2, the Host 15 (also can be device 8 as below) send its measurement order signals to the detector(s) (not shown, as below) by path 17 and receive the test information back through 16 and automatically send its diagnostic information to monitor 12 by 14 to clearly show them on monitor 12. The selecting information from 12 be sent to said the Host by path 13, following the selected orders, said the Host send its treatment order to the detector(s) to treat the person (not marked). In other situation, if said the Host already get the order for automatically treatment program, then after 16, said the Host will automatically send treatment order to the detectors to treat that person directly by path 18. The 19 just showing the way of manually selection (like switch) for treatment, like touch screen selection on the 12. In FIG. 2 the just showing the database can be shared with any other IT and let the latter to get some extent functions of measurement, diagnostic and treatment; for example, the cellphone.

The Host 15 can be automatically set the program of continually repeat the steps from 17, 16, and 18 in set the time. And during the set time, said the Host can automatically select different acupoints to set its treatment or measurement information on them by the meridians timing activation law software program(s).

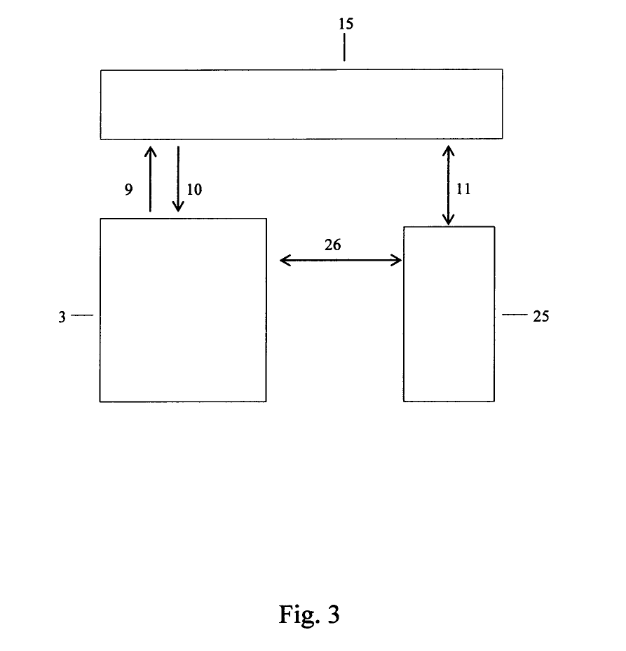

In the FIG. 3, showing the medicinal worker like doctor 25, manually work on said the device, the doctor join his/her analyses and diagnoses with said the device, and make their decisions for the continue treatment or not.

As the examples that said the invention system can be used for normal person which including as following individual named (but never limited) diseases' and its symptoms person for their meridians' acupoints measurement or treatment, or both, they are grouped in:

1. Plant people, Dementia. Alzheimer's disease, Amnesia, Mental retardation, Depression. Stroke, Paralysis including caused by accident. Optic nerve atrophy. Color blindness, visual correction.

2. Hypertension, low blood pressure, cardiac arrhythmia, heart failure,

3. Various kinds of cancers.

4 Renal failure, Impotence, prostatic hypertrophy

5 Glaucoma, diabetics,

6 Various allergy symptoms, seasonal allergy symptoms.

7 Body weight controls

8 Bone fracture healing

9 Various acute injury and various acute or chromic pains. Arthritic and rheumatoid arthritis.

10 Anyone who's acupoints' measuring data deviation from the normal volume which set by said invention system and the Unified Indexes of the databases the system collected.

11 The studies for any medicine's effect(s) to the normal and abnormal living bodies

12 The studies for any stimulating way to the person s for the effect(s) to the normal and abnormal living bodies.

My claims:

1. An Intelligent system applies to measure various bio-items from body's meridians' and acupoints' and also supply automatically diagnosis and treatment services, and according to the various measured volumes set up various database and their Unified indexes. The system can collect each corresponding measure data from the body's acupoints' and based on them the system will set its database programing with MTAL (which also comprising acupoint active time) and the standard volumes, again, based on them the system has the functions of diagnosis, and suggestion programs for treatment which can be manually select or by automatically preformed, and suggest measuring point(s) before and after treatment. The system is programing by self-study functions which can automatically collect the data information from each kind of measured and treated case to enrich its databases and to correct and complete system's Unified Indexes. The databases are from various measured data treated by statistically with different statistic factors and different MTAL. According to at least one of the MTAL, said the system program could let it set up its diagnostic conclusion(s) for the case and the treatment program for treatment. Said the system comprising at least one ICH or IT for running the system's software. Said device can link with a monitor/screen by wire or wireless for showing its information by word, figure, picture table and curve, sound and image, and the monitor/screen can be attach-screen. Said the device can link with at least one measurement detector(s) which has one or more different function(s) to measure different test-item(s) from the body, said the device at least can link with at least one treatment detector(s) to carry out at least one treatment program(s). There is at least one detector linking to said the device can has at least one of the following functions of: can measure body for at least one test-item, transfer the information back to said the device, following the order information from said the device to carry out treatment program(s). Each detector can has one or more than one function(s) of: measurement (including one or more different test-item(s)), treatment (including one or more different treatment) item(s)). Said the detector can detect body at the surface of the skin or inside of the skin. Said the detector can comprise by any shape and size, comprising any material. The system has at least one any kind mode for get his power for working. Said the device can accept the signal from the detector(s) and transfer them as word, figure, picture table and curve, sound and image and sand them back to said screen. Said the device can be linked with any other Host or IT by wire or wireless and can agree with and or refuses the data exchange between them.

2. According to the claim 1, said the system can collecting at least one mci, from said detector measure from body's point by at least one of following way(s) to measure at least one of following measurement item(s), and can record, store, transfer, them into any signal which the system need for its functions' working:
a. The way of said system measure persons' body's mci without extra power for the testing detector(s) (means no power from the detector(s)) going to the body's anywhere direct measure the body acupoint(s)'s mci and transfer the information to the device for treatment. OR the way of said system measure persons' body's mci with extra power from the testing detector(s) (means there has power from the detector(s)) going to the body's anywhere transfer the information to the device for treatment.
i. said the mci test including at least one of following test item between two points of the body: Current and its intensity and frequencies and waveform, Conductivity, Voltage, Capacitance, Magnetic field including its' strength and polarity.
ii. said the mci including at least one of following test item in any single point of the body Magnetic field including its' strength and polarity, temperature, microwave including light and their intensity and frequencies, The sounds and their waves and intensity. The pH value.
b. This invention involved meridians and their acupoints name and their locations are following the standards order of the Chinese Standard BB-12345-90. In addition to this, my invention expand the definition of the mane for the Ah-Shi acupoint: except the acupoints which are named before in the GB-12346-90, any other position of skin are definited here as “Ah-Shi” acupoints; they are thought as belong to some ‘Sun’ very fine-meridian which the point may sometimes, reacting for some specific illness by painfulness, however, they may not always like that.
c. According to the claim 2b, the measurement point can be on the surface, in vivo, or the detector is within 5 cm above the skin.

3. According to the claim 1, said system has been pre-prepared at least one of software(s) program of MTAL which listed as following at any step of said the system in said the programing with meridian measuring data for said the standard databases: their names also spelled by Chinese and their Ping Ying in following:
a Zi-Wu Liu ZU, ( [symbol] ) which also including at least one of following method
i Zi-Wu Liu ZU Na Jia ( [symbol] ) methods, also including at least one of following method:
1 Zhu Ri An Shi Qu Xue ( [symbol] [symbol] ) method: means according date and hour to counting the time for said acupoint.
2 Ke Qu Xue ( [symbol] [symbol] ), method: means: Back-restraint method to decide said acupoint(s).
b Zi-Wu Li ZU Na Zhi ( [symbol] , [symbol] ) methods, which also including at least of following method:
i Bu Mu Xie Zi [symbol] method, means: supplement upstream of said meridian flow and shunt away downstream of said meridian flow
ii Zhu Ke open acupoint method ( [symbol] ).
1 Yi Ri Liu shi Liu Xue method ( [symbol] ) means the method can select acupoint(s) from sixty six acupoints' per day to treat them.
2 Xun Jing Kai Xue method, [symbol] means: Following the day's of activity meridian to select opened acupoint(s)
3 Fei Teng Ba method ( [symbol] ).
4 Ling Gui Ba method [symbol]
c And any other method which with any time law to treat the meridian and their acupoint(s) to pre-decide the acupoint(s) to be treating.

4. According to the claim 1, said the time for the MTAL based on at least one of following timing method:
a. Gregorian Calendar,
b. Chinese Traditional Calendar.
c. Gregorian Calendar pluses Chinese Calendar.
d. Chinese specific Gan-Zhi ( [symbol] ) timing method.
e. According to the claim 4d, said the timing method also refer to at least one of following time circle:
i One Dimension timing method: HOURS, One HOURS equal to two usual hours. Twelve HOURS equal to One Chinese-day (Cday) and it start from 11:00 pm of Gregorian day to 10:59:59 of next Gregorian day, and twelve HOURs as one small daily cycle And sixty HOURS are set as big daily cycle.
ii Two Dimension timing method: Sixty Cdays are set as one Cday's cycle.
iii Third Dimension timing method refers to the Chinese Month's conception: one Chinese Year as small Chines Month's cycle (sCMC), Five sCMC are set as one Big Chinese Month Cycle (bCMC)
iv Fourth Dimension timing method: Every sixty Chinese Year are set as one Chinese Year Cycle (CYC)
f. Following the at least one of MTAL, match and point out any body's special active meridian's acupoint(s) at a specific times.

5. According to the claim 1, said the system automatically classify and statistically treat the mci measured data by MTAL and at least one of following factor to get their statistically standard and Unified Index(s):
a Persons' health background and their Gender and their Date of Birth and named each group which separately classified by the persons' health history background; marked with ‘health’ or ‘specific disease’, and many more.
b According the claim 5a, the each database may also be classically treated with or without other following different factors: Longitude of the place of birth, Height, Body weight, Career, Education background, Religious belief, living area, Diet habit, and also, Physiological cycle, of different physiological condition.

6. According the claim 5a, the system can automatically:
a According to the claim 1, said system can measure the person's body by measurement detector at the point said in claim 2b to measure the item said in claim 2a following the timing method said as claim 4 and following the MTAL said in claim 3 automatically treat said each of measure data and compare these data with relative health standard value said in claim 5,
b According to the claim 6b, if any person's any mci test value is within the relative health data value said the system can make its diagnostic conclusion for that person THIS item inner condition is “Health”. If any person's all mci test values are within the relative health values said the system will make its diagnostic conclusion for that persons all tested inner conditions are HEALTH. If the person's any mci test value is out of relative health standard value, said the system can automatically match the data with all specific groups which have been classified and statistically treated for their database into different named disease groups said in claim 5, and make its diagnostic conclusion for that person's health condition with specific marched disease group's name.
c According to the claim 6b, after said the system make its diagnostic conclusion for tested person, said the system can automatically according at least one of the MTAL listed in the claim 3, with at least one of the timing method which listed at claim 4, with at least one kind of treatment method/content listed in claim 2 to set up the health-care treatment program from said the device to body's special point with special time period by the way of:
i Said the treatment program directly following the detector to treat the person.
ii Said the treatment grogram information are showing on the screen for manually selection.
d According to the claim 6c, said the treatment program including at least one of following content(s)
i At least one of following stimulation content: direct needle treatment. Shake, Worm with the method of by air or liquid or any solid material, Current and its polarity and intensity and frequencies and waveform and voltage, Magnetic field with any strength and any polarity. Microwave including light with any intensity and frequencies. The sounds and their any waves and any intensity. The ultrasonic with any intensity which couldn't damage body. The liquid with the pH value between the 1-14 with any concentration.
i The point(s) said in claim 2b also can be treatment point(s).
ii Length of time, showing as usual Gregorian time.
e According to the claim 6c, said the system can also send its treatment program signals to the screen which linked with said device to let medical worker joint his/her suggestion and make final decision to treat the person by detector.
f According to the claim 6a, said the measurement detector can also carry out at least one of treatment function which listed in claim 6d.
g According to the claim 6a, the test method used for find new acupoint(s).
h According to the claim 6d-i, the treatment point use on the surface, in vivo, or the detector is within 50 cm above the skin. The number of treatment point is at least one.

7. According to the claim 1, said the system can be used for the drug testing by measure the person's meridian/acupoint according to the claim 6a before and after dosing the drug which by any way listing in following way but never limited:
a oral.
b breathe in.
c smear.
d mucosa.
e Intestine.
f Injection from at least one way listed following but never limited:
i By vein.
ii by artery.
iii By subcutaneous.
iv by muscle
v by chest.
vi By abdominal cavity.
vii By joint cavity.

8. An Intelligent system which can measure living body's any points for any original bio-signal(s) and record measured original bio-signal(s) and stimulate back to any living body by any point for any of following (but never limited) purpose:
a For supplying Biologic Energy Nutrition to living life for their health.
b For balance living's inner condition.
c Partially or completely instead food by input bio-energy to the living body.
d Rescue dying person.
e Living life body' organ regeneration.
f Infertility.
g Research TCM the energy ‘QI’ ( [symbol] ) and to prove it.
h Research human potential and development it.
i Living lives' personality conversion by change their bio-information conversion, including treat violent character.
j Research drugs effects in living body' including:
i To research which meridian will be effected by said used drug?
ii Research any herb active ingredient for the diseases' treatment.
iii To research under the drug loading condition, measure some bio-signal and record them and return to sick living body to instead drug.

9. According to the claim 8, said the original signals used to exchange between different living live for the living bodies.

10. According to the claim 1, said the MTAL programs can be programed in any step of said system's programings.

11. According to the claim 1, said the system which programed any MTAL grogram used in any race to prove, research and applicant for said the MTALs to deal with Any Data which include but never limited any meridian and acupoints' measuring data directly or indirectly.

12. According to the claim 1,
a said the system which programed any MTAL grogram used in any race to prove, research and applies for said the MTALs
b said the system which programed any MTAL grogram used in any race to prove, research and applies for said the MTALs to deal with any meridian and acupoints' measuring data directly or indirectly.
c said the system which programed any MTAL grogram used in any race to prove, research and applies for said the MTALs to deal with Any data which include but never limited for what is currently being used and any new method of clinic examination and their data.

13. Keep all right for any further change, further development for all above claim.
